(19) United States
(12) Patent Application Publication
(10) Pub. No.: US 2006/0032765 A1
(43) Pub. Date: Feb. 16, 2006

(54) Transparent polypropylene containers for packaging shoes

(75) Inventors: Friederike Morhard, Ferrara (IT); Johan De Clippeleir, Oud heverlee (BE)

Correspondence Address: BASELL USA INC., INTELLECTUAL PROPERTY, 912 APPLETON ROAD, ELKTON, MD, 21921, US

(73) Assignee: Basell Polyolefine, Wesseling (DE)

(21) Appl. No.: 10/526,791

(22) PCT Filed: Apr. 28, 2004
(86) PCT No.: PCT/EP04/04453

§ 371 Date: Jun. 20, 2005

(30) Foreign Application Priority Data
May 7, 2003 (DE) 10320647.7

(51) Int. Cl. B65D 85/18; B65D 85/20; B65D 25/54; B32B 27/08

(52) U.S. Cl. 206/278; 206/315.1; 206/769; 428/35.7

(57) ABSTRACT

The present invention relates to the use of containers comprising transparent polypropylene for packaging or storing articles from the area of clothing, sports articles, toys or home worker articles, with the containers having wall thicknesses of at least 0.8 mm, and the transparent polypropylene is a propylene homopolymer or propylene copolymer which has a haze value ≦40%, based on a thickness of polypropylene of 1 mm and measured on injection-molded test specimens, and has a tensile modulus of ≧700 MPa and a Charpy notched impact strength at 0° C. of ≧3 kJ/m². In addition, the invention relates to containers comprising transparent polypropylene which are suitable for packaging purposes and also systems comprising containers made of a transparent polymer which are suitable for packaging or storing articles from the area of clothing, sports articles, toys or home worker articles.

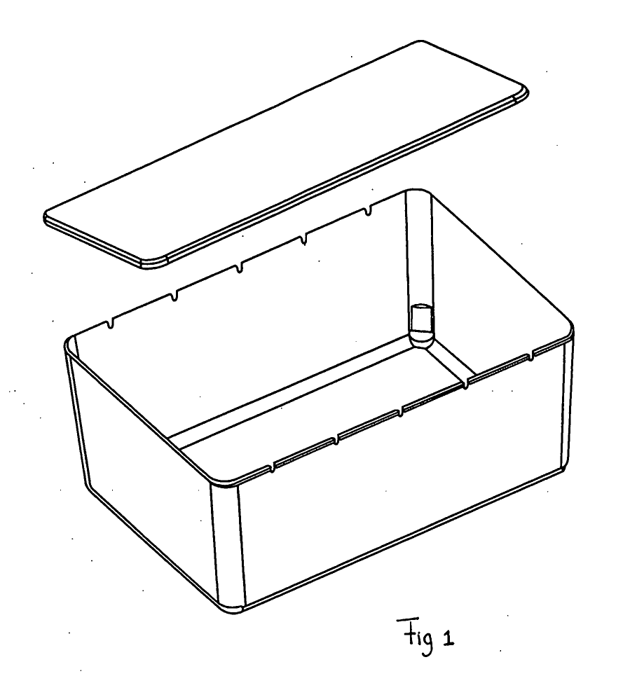

The present invention relates to the use of containers made of transparent polypropylene for packaging or storing articles from the area of clothing, sports articles, toys or home worker articles and in particular shoes, specifically transparent polypropylene containers suitable for packaging shoes and also systems comprising containers made of a transparent polymer which are suitable for packaging or storing articles from the area of clothing, sports articles or toys.

Two part cardboard boxes consisting of a box and a lid are frequently used for packaging articles from the area of clothing, sports articles or toys and in particular for packaging shoes. A disadvantage of this type of packaging is its often unsatisfactory mechanical stability, particularly when many such cardboard boxes are stacked on top of one another, as is customary in many shoe shops. Furthermore, it is not unusual for the packaging and especially the lid to be damaged when lower boxes are pulled out from a stack of cardboard boxes, since the lid is frequently grasped for pulling out the box.

A further disadvantage of cardboard packaging is that the contents of the box cannot be seen. This means that it is either necessary to take the goods from the cardboard box to enable them to be displayed in a shop or the customers and the sales staff can obtain information on the contents only from inscriptions on the outside of the cardboard box. This is also disadvantageous in places where shoes regularly have to be taken from the cardboard boxes and then put back in, since incorrectly positioned shoes are not easy to find and when errors are discovered, it is a complicated procedure to restore the original order.

A further disadvantage of such cardboard packaging is its low reuse value. Such packaging is thus essentially disposable packaging which has to be disposed of either by the purchaser or by the vendor of the articles, which is associated with considerable costs.

Reusable packaging, in particular for shoes, made of plastic is known, for example, from EP-A 659 649. The containers disclosed there have a foldable frame and side sections made of a flexible material which can be folded together.

Shoe boxes made of a transparent or translucent plastic are described in WO 86/07576. However, the plastics from which the shoe boxes can be produced particularly advantageously are not disclosed.

Polypropylenes constitute a class of plastics which is frequently well-suited to packaging applications. These generally have advantageous mechanical properties such as satisfactory hardness, stiffness and dimensional stability. They are also economically advantageous.

However, the toughness, in particular at low temperatures, the stress whitening behavior, the distortion and especially the transparency frequently leaves something to be desired.

It is an object of the present invention to overcome the abovementioned disadvantages of the prior art and to find containers which are suitable for packaging articles from the area of clothing, sports articles or toys and have good mechanical properties, enable the packaging to be handled easily and can be produced economically and with low distortion.

We have found that this object is achieved by the use of containers comprising transparent polypropylene for packaging or storing articles from the area of clothing, sports articles, toys or home worker articles, with the containers having wall thicknesses of at least 0.8 mm, wherein the transparent polypropylene is a propylene homopolymer or propylene copolymer which has a haze value of ≦40%, based on a thickness of the polypropylene of 1 mm and measured on injection-molded test specimens, and has a tensile modulus of ≧700 MPa and a Charpy notched impact strength at 0° C. of ≧3 kJ/m².

Furthermore, we have found containers comprising transparent polypropylene which are suitable for packaging purposes and also systems comprising containers comprising a transparent polymer which are suitable for packaging or storing articles from the area of clothing, sports articles, toys or home worker articles.

According to the present invention, a transparent polypropylene is used for producing the containers. For the present purposes, the term polypropylene refers to a polymer produced from monomers comprising at least 50% by weight of propylene. Possible comonomers are, in particular, α-olefins, i.e. hydrocarbons having terminal double bonds. Preferred α-olefins are linear or branched C₂-C₂₀-1-alkenes other than propylene, in particular linear C₂-C₁₀-1-alkenes or branched C₂-C₁₀-1-alkenes such as 4-methyl-1-pentene, conjugated and nonconjugated dienes such as 1,3-butadiene, 1,4-hexadiene or 1,7-octadiene or vinylaromatic compounds such as styrene or substituted styrene. Further suitable olefins are ones in which the double bond is part of a cyclic structure which may comprise one or more ring systems. Examples are cyclopentene, norbornene, tetracyclododecene and methylnorbornene and dienes such as 5-ethylidene-2-norbornene, norbornadiene or ethylnorbornadiene. It is also possible for mixtures of two or more olefins to be copolymerized with propylene. Particularly preferred olefins are ethylene and linear C₄-C₁₀-1-alkenes such as 1-butene, 1-pentene, 1-hexene, 1-heptene, 1-octene, 1-decene and in particular ethylene and/or 1 -butene.

The transparent polypropylene used according to the present invention for producing the containers has a haze value, based on a thickness of the polypropylene of 1 mm and measured on injection-molded test specimens in accordance with the standard ASTM D 1003, of ≦40%, preferably ≦25%, particularly preferably ≦15% and very particularly preferably ≦12%. The haze value is a measure of the opacity of the material and is thus a parameter which characterizes the transparency of the material. The lower the haze value, the higher the transparency.

The transparent polypropylene also has an advantageous combination of stiffness and toughness. The tensile modulus of the transparent polypropylene is ≧700 MPa and preferably ≧800 MPa, measured in accordance with ISO 527-2:1993. To determine the tensile modulus, preference is given to injection molding a test specimen of type 1 having a total length of 150 mm and a parallel section of 80 mm at a melt temperature of 250° C. and a tool surface temperature of 30° C. To allow further crystallization to occur, the test specimen is then stored for 7 days under standard conditions of 23° C./50% atmospheric humidity. The strain rate in the determination of the modulus should be 1 mm/min. The toughness of the transparent polypropylene, determined as the Charpy notched impact strength at 0° C., is 23 kJ/m², preferably 24 kJ/m² and particularly preferably ≧6 kJ/m². The Charpy notched impact strength is measured in accordance with the standard ISO 179-2/1 eU.

The transparent polypropylene also displays good stress whitening behavior. For the present purposes, stress whitening is the occurrence of whitish discoloration in the stressed region when the polymer is subjected to mechanical stress. It is generally believed that the whitening is caused by small voids being formed in the polymer under mechanical stress. Good stress whitening behavior means that no or only very small regions of whitish discoloration occur under mechanical stress.

One method of quantifying stress whitening behavior is to subject defined test specimens to a defined impact stress and then to measure the size of the resulting white spots. Accordingly, the dome indenter method involves allowing a falling dart to drop onto a test specimen using a falling dart apparatus in accordance with DIN 53443 part 1. A falling dart having a mass of 250 g and an impact head diameter of 5 mm is used here. The dome radius is 25 mm and the height from which the dart is dropped is 50 cm. Injection-molded round disks having a diameter of 60 mm and a thickness of 2 mm are used as test specimens, and each test specimen is subjected to only one impact test. The stress whitening is reported in mm as the diameter of the visible stress whitening mark, and the value reported is the mean of in each case 5 test specimens, with the individual values being determined on the side of the round disk opposite the side on which impact occurs as a mean of the two values in the flow direction on injection molding and perpendicularly thereto.

The transparent polypropylene displays no or only very little stress whitening at 23° C., determined by the dome indenter method. In the case of preferred transparent polypropylenes, a value of from 0 to 8 mm, preferably from 0 to 5 mm and in particular from 0 to 2.5 mm, is determined at 23° C. using the dome indenter method.

Suitable transparent polypropylenes are homopolymers of propylene or preferably copolymers of propylene obtained using catalyst systems based on metallocene compounds.

Suitable transparent polypropylenes can also be heterophase propylene copolymers, also known as multiphase propylene copolymers or as propylene block copolymers. Such compositions usually have demixed phases, generally with a polyolefin having a relatively low stiffness being dispersed in the matrix of a propylene polymer having a higher stiffness.

Heterophase propylene copolymers suitable as transparent polypropylenes are, for example, ones comprising a copolymer of ethylene and 1-butene as soft phase.

Particularly useful heterophase propylene copolymers are copolymers comprising a propylene polymer A forming the matrix and a propylene copolymer B dispersed therein, with the heterophase propylene copolymers having been prepared using catalyst systems based on metallocene compounds.

The propylene polymer A can be a propylene homopolymer or a copolymer of propylene with up to 15% by weight and preferably up to 10% by weight of olefins other than propylene, with preferred propylene copolymers containing from 1.5 to 7% by weight, in particular from 2.5 to 5% by weight, of olefins other than propylene. As comonomer, preference is given to using ethylene or linear C₄-C₁₀-1-alkenes or mixtures thereof, in particular ethylene and/or 1-butene.

The propylene copolymers B usually contain from 5 to 40% by weight of olefins other than propylene. It is also possible for two or more different propylene copolymers which may differ both in respect of the comonomer content and in respect of the type of the olefin(s) other than propylene to be used as component B. Preferred comonomers are ethylene and linear C₄-C₁₀-1-alkenes or mixtures thereof, in particular ethylene and/or 1-butene. In a further preferred embodiment, monomers containing at least two double bonds, e.g. 1,7-octadiene or 1,9-decadiene, are additionally employed. The content of olefins other than propylene in the propylene copolymers is generally from 7 to 25% by weight, preferably from 10 to 20% by weight, particularly preferably from 12 to 18% by weight and in particular from 14% by weight to 17% by weight, based on the propylene copolymer B.

The weight ratio of propylene polymer A to propylene copolymer B can vary. It is preferably from 90:10 to 60:40, particularly preferably from 80:20 to 60:40 and very particularly preferably from 70:30 to 60:40, with propylene copolymers B being able to be all propylene copolymers forming the component B.

Such a preferred transparent polypropylene preferably has a narrow molar mass distribution M_{w}/Mₙ. For the purposes of the invention, the molar mass distribution M_{w}/Mₙ is the ratio of the weight average molar mass M_{w} and the number average molar mass Mₙ. The molar mass distribution M_{w}/Mₙ is preferably in the range from 1.5 to 3.5, particularly preferably in the range from 1.8 to 2.5 and in particular in the range from 2 to 2.3.

The average molar mass Mₙ of such a preferred transparent polypropylene is preferably in the range from 20 000 g/mol to 500 000 g/mol, particularly preferably in the range from 50 000 g/mol to 200 000 g/mol and very particularly preferably in the range from 80 000 g/mol to 150 000 g/mol.

To prepare such a preferred transparent polypropylenes, preference is given to using catalyst systems based on metallocene compounds of transition metals of group 3, 4, 5 or 6 of the Periodic Table of the Elements.

Particular preference is given to catalyst systems based on metallocene compounds having the formula (I), 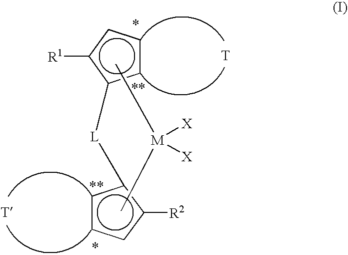
where

M is zirconium, hafnium or titanium, preferably zirconium,

X are identical or different and are each, independently of one another, hydrogen or halogen or an —R, —OR, —OSO₂CF₃, —OCOR, —SR, —NR₂ or —PR₂ group, where R is linear or branched C₁-C₂₀-alkyl, C₃-C₂₀-cycloalkyl which may bear one or more C₁-C₁₀-alkyl radicals as substituents, C₈-C₂₀-aryl, C₇-C₂₀-alkylaryl or C₇-C₂₀-arylalkyl and may contain one or more hetero atoms of groups 13-17 of the Periodic Table of the Elements or one or more unsaturated bonds and is preferably C₁-C₁₀-alkyl such as methyl, ethyl, n-propyl, isopropyl, n-butyl, isobutyl, sec-butyl, tert-butyl, n-pentyl, n-hexyl, n-heptyl or n-octyl or C₃-C₂₀-cycloalkyl such as cyclopentyl or cyclohexyl, where the radicals X may also be joined to one another and preferably form a C₄-C₄₀-dienyl ligand, in particular a 1,3-dienyl ligand, or an —OR′O—, group in which the substituent R′ is a divalent group selected from the group consisting of C₁-C₄₀-alkylidene, C₆-C₄₀-arylidene, C₇-C₄₀-alkylarylidene and C₇-C₄₀-arylalkylidene, where X is preferably a halogen atom or an —R or —OR group or the two radicals X form an —OR′O-group and X is particularly preferably chlorine or methyl,

L is a divalent bridging group selected from the group consisting of C₁-C₂₀-alkylidene, C₃-C₂₀-cycloalkylidene, C₆-C₂₀-arylidene, C₇-C₂₀-alkylarylidene and C₇-C₂₀-arylalkylidene radicals which may contain hetero atoms of groups 13-17 of the Periodic Table of the Elements, or is a silylidene group having up to 5 silicon atoms, e.g. —SiMe₂— or —SiPh₂—, where L is preferably a radical selected from the group consisting of —SiMe₂—, SiPh₂—, —SiPhMe—, —SiMe(SiMe₃), —CH₂—, —CH₂)₂—, —CH₂)₃— and C(CH₃)₂,

R¹ is linear or branched C₁-C₂₀-alkyl, C₃-C₂₀-cycloalkyl, which may bear one or more C₁-C₁₀-alkyl radicals as substituents, C₈-C₂₀-aryl, C₇-C₂₀-alkylaryl or C₇-C₂₀-arylalkyl and may contain one or more hetero atoms of groups 13-17 of the Periodic Table of the Elements or one or more unsaturated bonds, where R¹ is preferably unbranched in the a position and is preferably a linear or branched C₁-C₁₀-alkyl group which is unbranched in the a position, in particular a linear C₁-C₄-alkyl group such as methyl, ethyl, n-propyl or n-butyl,

R² is a group of the formula —C(R³)₂R⁴, where

R³ are identical or different and are each, independently of one another, linear or branched C₁-C₂₀-alkyl, C₃-C₂₀-cycloalkyl which may bear one or more C₁-C₁₀-alkyl radicals as substituents, C₆-C₂₀-aryl, C₇-C₂₀-alkylaryl or C₇-C₂₀-arylalkyl and may contain one or more hetero atoms of groups 13-17 of the Periodic Table of the Elements or one or more unsaturated bonds, or two radicals R³ may be joined to form a saturated or unsaturated C₃-C₂₀ ring,

where R³ is preferably a linear or branched C₁-C₁₀-alkyl group, and R⁴ is hydrogen or linear or branched C₁-C₂₀-alkyl, C₃-C₂₀-cycloalkyl which may bear one or more C₁-C₁₀-alkyl radicals as substituents, C₆-C₂₀-aryl, C₇-C₂₀-alkylaryl or C₇-C₂₀-arylalkyl and may contain one or more hetero atoms of groups 13-17 of the Periodic Table of the Elements or one or more unsaturated bonds, where R⁴ is preferably hydrogen,

T and T′ are divalent groups of the formulae (II), (III), (IV), (V) or (VI), 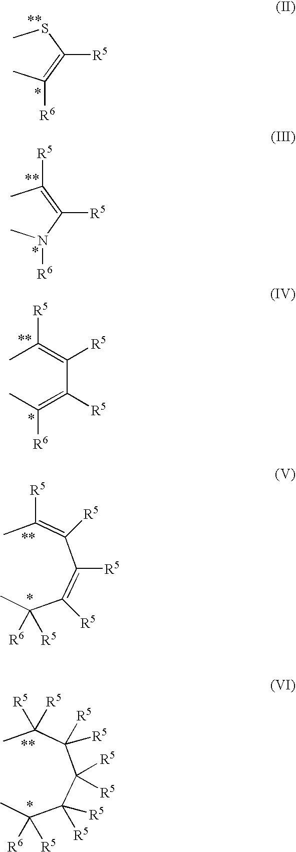
where
the atoms denoted by the symbols *and ** are in each case bound to the atoms of the compound of the formula (I) which are denoted by the same symbol, and

R⁵ are identical or different and are each, independently of one another, hydrogen or halogen or linear or branched C₁-C₂₀-alkyl, C₃-C₂₀-cycloalkyl which may bear one or more C₁-C₁₀-alkyl radicals as substituents, C₆-C₂₀-aryl, C₇-C₂₀-alkylaryl or C₇-C₂₀-arylalkyl and may contain one or more hetero atoms of groups 13-17 of the Periodic Table of the Elements or one or more unsaturated bonds, where R⁵ is preferably hydrogen or a linear or branched C₁-C₁₀-alkyl group, in particular a linear C₁-C₄-alkyl group such as methyl, ethyl, n-propyl or n-butyl, and

R⁶ are identical or different and are each, independently of one another, halogen or linear or branched C₁-C₂₀-alkyl, C₃-C₂₀-cycloalkyl which may bear one or more C₁-C₁₀-alkyl radical as substituents, C₆-C₂₀-aryl, C₇-C₂₀-alkylaryl or C₇-C₂₀-arylalkyl and may contain one or more hetero atoms of groups 13-17 of the Periodic Table of the Elements or one or more unsaturated bonds,

where R⁶ is preferably an aryl group of the formula (VII), 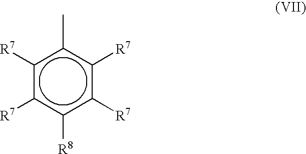
where

R⁷ are identical or different and are each, independently of one another, hydrogen or halogen or linear or branched C₁-C₂₀-alkyl, C₃-C₂₀-cycloalkyl which may bear one or more C₁-C₁₀-alkyl radicals as substituents, C₆-C₂₀-aryl, C₇-C₂₀-alkylaryl or C₇-C₂₀-arylalkyl and may contain one or more hetero atoms of groups 13-17 of the Periodic Table of the Elements or one or more unsaturated bonds, or two radicals R⁷ may be joined to form a saturated or unsaturated C₃-C₂₀ ring, where R⁷ is preferably a hydrogen atom, and

R⁸ is hydrogen or halogen or linear or branched C₁-C₂₀-alkyl, C₃-C₂₀-cycloalkyl which may bear one or more C₁-C₁₀-alkyl radicals as substituents, C₆-C₂₀-aryl, C₇-C₂₀-alkylaryl or C₇-C₂₀-arylalkyl and may contain one or more hetero atoms of groups 13-17 or the Periodic Table of the Elements or one or more unsaturated bonds, where R⁸ is preferably a branched alkyl group of the formula —C(R⁹)₃, where

R⁹ are identical or different and are each, independently of one another, a linear or branched C₁-C₆-alkyl group or two or three radicals R⁹ are joined to form one or more ring systems.

Preference is given to at least one of the groups T and T′ being substituted by a radical R⁹ of the formula (VII), and particular preference is given to both groups being substituted by such a radical. Very particular preference is given to at least one of the groups T and T′ being a group of the formula (IV) which is substituted by a radical R⁶ of the formula (VII) and the other having either the formula (II) or (IV) and likewise being substituted by a radical R⁶ of the formula (VII).

Very particular preference is given to catalyst systems based on metallocene compounds of the formula (VIII),

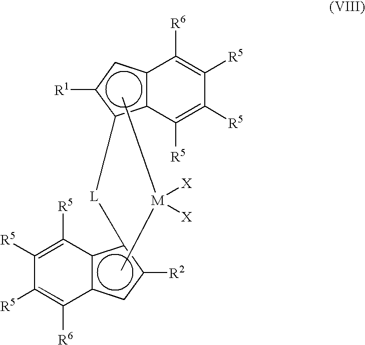

Particularly useful metallocene compounds and processes for preparing them are described, for example, in WO 01/48034 and the international patent application No. PCT/EP02/13552.

It is also possible to use mixtures of various metallocene compounds or mixtures of various catalyst systems. However, preference is given to using only one catalyst system comprising one metallocene compound, with this being used for the polymerization of the propylene polymer A and the propylene copolymer B.

Examples of suitable metallocene compounds are

dimethylsilanediyl-(2-ethyl-4-(4′-tert-butylphenyl )indenyl)-(2-isopropyl-4-(4′-tert-butylphenyl)indenyl)zirconium dichloride,

dimethylsilanediyl-(2-methyl-4-(4′-tert-butylphenyl)indenyl)-2-isopropyl 4-(1-naphthyl)indenyl)zirconium dichloride,

dimethylsilanediyl-(2-methyl-4-phenyl)- -indenyl)-(2-isopropyl-4-(4′-tert-butylphenyl)-1-indenyl)zirconium dichloride,

dimethylsilanediyl-(2-methylthiapentenyl)-(2- isopropyl-4-(4′-tert-butylphenyl)indenyl)zirconium dichloride,

dimethylsilanediyl-(2-isopropyl-4-(4′-tert-butylphenyl)indenyl)-(2-methyl-4,5-benzindenyl)zirconium dichloride,

dimethylsilanediyl-(2-methyl-4-(4′-tert-butylphenyl)indenyl)-(2-isopropyl-4-(4 ′-tert-butylphenyl) indenyl)zirconium dichloride,

dimethylsilanediyl-(2-methyl-4-(4′-tert-butylphenyl)indenyl)zirconium dichloride,

dimethylsilanediyl-(2-ethyl-4-(4′-tert-butylphenyl)indenyl)-(2-isopropyl-4-phenyl)indenyl)zirconium dichloride or

dimethylsilanediyl-(2-isopropyl-4-(4′-tert-butylphenyl)indenyl)-(2-methyl-4-(1-naphthyl)indenyl)zirconium dichloride

or mixtures thereof.

In addition, the preferred catalyst systems based on metallocene compounds generally further comprise compounds capable of forming metallocenium ions as cocatalysts. Suitable cocatalysts include strong, uncharged Lewis acids, ionic compounds having Lewis-acid cations and ionic compounds containing Brönsted acids as cation. Examples are tris(pentafluorophenyl)borane, tetrakis(pentafluorophenyl)borate and salts of N,N-dimethylanilinium. Further compounds which are suitable as compounds capable of forming metallocenium ions and thus as cocatalysts are open-chain or cyclic aluminoxane compounds. These are usually prepared by reacting trialkylaluminum with water and are generally present as mixtures of both linear and cyclic chain molecules of various lengths or cage molecules of various sizes. The preferred catalyst systems based on metallocene compounds are usually employed in supported form. Suitable supports are, for example, porous organic or inorganic inert solids such as finely divided polymer powders or inorganic oxides, for example silica gel. The metallocene catalyst systems may further comprise organometallic compounds of the metals of groups 1, 2 and 13 of the Periodic Table, e.g. n-butyllithium or aluminum alkyls.

In the preparation of the particulary preferred heterophase compositions, preference is given to firstly polymerizing the propylene polymer A in a first stage by polymerizing, based on the total weight of the mixture, from 90% by weight to 100% by weight of propylene, if desired in the presence of further olefins, usually at from 40° C. to 120° C. and pressures in the range from 0.5 bar to 200 bar. In a second stage, a mixture of from 2 to 95% by weight of propylene and from 5% to 98% by weight of further olefins is subsequently polymerized onto the polymer obtainable by the reaction of the first stage, usually at from 40° C. to 120° C. and pressures in the range from 0.5 bar to 200 bar. The polymerization of the propylene polymer A is preferably carried out at from 60 to 80° C., particularly preferably from 65 to 75° C., and a pressure of from 5 to 100 bar, particularly preferably from 10 bar to 50 bar. The polymerization of the propylene copolymer B is preferably carried out at from 60 to 80° C., particularly preferably from 65 to 75° C., and a pressure of from 5 to 100 bar, particularly preferably from 10 bar to 50 bar.

Customary additives, for example molar mass regulators such as hydrogen or inert gases such as nitrogen or argon, can also be used in the polymerization.

The composition of the propylene copolymers B of such preferred transparent polypropylenes prepared using catalyst systems based on metallocene compounds is preferably uniform. They comprise little comonomer incorporated in blocks. The expression “incorporated in blocks” is used to mean that two or more comonomer units follow one another directly. In preferred propylene copolymers B obtained from propylene and ethylene, the structure can be determined by ¹³C-NMR spectroscopy. Evaluation of the spectra is prior art and can be carried out by a person skilled in the art using, for example, the method of H. N. Cheng, Macromolecules 17 (1984), pp. 1950-1955, or L. Abis et al., Makromol. Chemie 187 (1986), pp.1877-1886. The structure can then be described by the proportions of “PEₓ” and of “PEP”, where PEₓ refers to propylene-ethylene units having 2 successive ethylene units and PEP refers to propylene-ethylene units having an isolated ethylene unit between two propylene units. Preferred propylene copolymer compositions obtained from propylene and ethylene have a PEP/PEₓ ratio in the range from 0.75 to ≦1, preferably the range from 0.85 to ≧1.4 and particularly preferably in the range from 0.85 to 1.2 and in particular in the range from 0.9 to 1.1.

In the case of the preferred use of ethylene as comonomer, particular preference is given to an ethylene content of the propylene copolymers B of from 10 bis 20% by weight, in particular from 12 to 18% by weight and particularly preferably about 16% by weight. The transparency of the propylene copolymer compositions used according to the present invention is virtually independent of the proportion of propylene copolymer B present.

Particularly useful heterophase propylene copolymers suitable as transparent polypropylenes are also ones comprising

A) from 50 to 98, preferably from 60 to 95% by weight of a crystalline propylene homopolymer, or a crystalline random copolymer of propylene with ethylene and/or C₄-C₁₀-1-alkenes, containing from 0.5 to 15% by weight of ethylene and/or C₄-C₁₀-1-alkenes; and

B) from 2 to 50, preferably from 5 to 40% by weight of (i) an elastomeric copolymer of ethylene with one or more C₄-C₁₀-1-alkenes (copolymer (a)), containing from 60 to 85% by weight of ethylene, or (ii) a blend of copolymer (a) with a copolymer of propylene with more than 15% up to 40% of ethylene (copolymer (b)), wherein the weight ratio (a)/(b) is preferably from ¼ to 4/1.

Examples of C₄-C₁₀-1-alkenes that can be used as comonomers in Fractions A and B are 1-butene, 1-pentene, 1-hexene and 4-methyl-1-pentene. Particularly preferred is 1-butene.

The MFR (230° C./2.16 kg) determined according to ISO 1133 of such heterophase propylene copolymers is preferably from 0.1 to 100 g/10 min.

Such useful heterophase propylene copolymers are typically prepared by sequential copolymerization of the monomers in the presence of stereospecific Ziegler-Natta catalysts supported on magnesium dihalides. The polymerization is carried out in at least two steps: in the first stage, one carries out the synthesis of the polymer of Fraction A, in the second one, the synthesis of the polymer of Fraction B. The synthesis of the latter occurs in the presence of the polymer obtained and the catalyst used in the preceding stage. Reaction times and temperatures relative to the two steps are not critical and are advantageously in the range from 0.5 to 5 hrs, and from 50° C. to 90° C. respectively. Regulation of the molecular weight is done by using molecular weight regulators commonly used, e.g. hydrogen and ZnEt₂.

Suitable stereospecific catalysts comprise the product of the reaction between:

i) a solid component, containing a titanium compound and an electron-donor compound (internal electron-donor) supported on magnesium chloride;

ii) an aluminum alkyl compound (cocatalyst); and, optionally,

iii) an electron-donor compound (external electron-donor).

Said catalysts are preferably capable of producing homopolymer polypropylene having an isotactic index higher than 90%. Catalysts having the above mentioned characteristics are well known in the patent literature; particularly advantageous are the catalysts described in U.S. Pat. No. 4,399,054 and EP-A 45977.

The solid catalyst component (i) contains as electron-donor a compound generally selected among the ethers, ketones, lactones, compounds containing N, P and/or S atoms, and mono- and dicarboxylic acid esters.

Particularly suited are phthalic acid esters and succinic acid esters. Other electron-donors particularly suited are the 1,3-diethers, as illustrated in published European patent applications EP-A 361 493 and EP-A 728 769.

As cocatalysts (ii), one preferably uses the trialkyl aluminum compounds, such as Al-triethyl, Al-triisobutyl and Al-tri-n-butyl.

The electron-donor compounds (iii) that can be used as external electron-donors (added to the Al-alkyl compound) comprise the aromatic acid esters (such as alkylic benzoates), heterocyclic compounds (such as the 2,2,6,6-tetramethylpiperidine and the 2,6-diisopropylpiperidine), and in particular silicon compounds containing at least one Si—OR bond (where R is a hydrocarbon radical). The previously said 1,3-diethers are also suitable to be used as external donors. In the case that the internal donor is one of the said 1,3-diethers, the external donor can be omitted.

The particularly useful transparent polypropylenes obtained by using catalyst systems based on metallocene compounds or by using stereospecific Ziegler-Natta catalysts supported on magnesium dihalides are preferably prepared in a multistage polymerization process having at least two polymerization stages connected in series, generally in the form of a reactor cascade. It is possible to use the customary reactors employed for the polymerization of propylene. The polymerization can be carried out in a known manner in bulk, in suspension, in the gas phase or in a supercritical medium. It can be carried out batchwise or preferably continuously. Solution processes, suspension processes, stirred gas-phase processes or gas-phase fluidized-bed processes are all possible. As solvent or suspension medium, it is possible to use inert hydrocarbons, for example isobutane, or else the monomers themselves. It is also possible for one or more stages of the process employed according to the present invention to be carried out in two or more reactors. The size of the reactors is not of critical importance for the process employed according to the present invention. It depends on the output which is to be achieved in the reaction zone or in the individual reaction zones.

Preference is given to processes in which the polymerization in the second stage, in which the propylene copolymer(s) B or fraction B are formed, takes place from the gas phase. The previous polymerization of the propylene polymers A or fraction A can be carried out either in bulk, i.e. in liquid propylene as suspension medium, or likewise from the gas phase. If all polymerizations take place from the gas phase, the process is preferably carried out in a cascade of stirred gas-phase reactors which are connected in series and in which the pulverulent reaction bed is kept in motion by means of a vertical stirrer. The reaction bed generally comprises the polymer which is polymerized in the respective reactor. If the initial polymerization of the propylene polymers A is carried out in bulk, the process is preferably in a cascade comprising one or more loop reactors and one or more gas-phase fluidized-bed reactors. The preparation can also be carried out in a multizone reactor.

The amount of monomers added in the individual stages and the process conditions such as pressure, temperature or the addition of molar mass regulators such as hydrogen are chosen so that the polymers formed have the desired properties.

Customary additives, for example molar mass regulators such as hydrogen or inert gases such as nitrogen or argon, can also be used in the polymerization.

The transparent polypropylenes generally further comprise additives known to those skilled in the art, e.g. stabilizers, lubricants and mold release agents, fillers, nucleating agents, antistatics, plasticizers, dyes, pigments or flame retardants, in customary amounts. These are generally incorporated during granulation of the pulverulent product obtained in the polymerization.

Customary stabilizers are antioxidants such as sterically hindered phenols, processing stabilizers such as phosphites or phosphonites, acid scavengers such as calcium stearate or zinc stearate or dihydrotalcite, sterically hindered amines or UV stabilizers, In general, the propylene copolymer compositions used according to the present invention contain one or more stabilizers in amounts of up to 2% by weight.

Suitable lubricants and mold release agents are, for example, fatty acids, calcium or zinc salts of fatty acids, fatty acid amides or low molecular weight polyolefin waxes, which are usually used in concentrations of up to 2% by weight.

Possible fillers are, for example, talc, chalk or glass fibers, which can usually be used in amounts of up to 50% by weight.

Suitable nucleating agents are, for example, inorganic additives such as talc, silica or kaolin, salts of monocarboxylic or polycarboxylic acids, e.g. sodium benzoate or aluminum tert-butylbenzoate, dibenzylidenesorbitol or its C₁-C₈-alkyl-substituted derivatives such as methyldibenzylidenesorbitol, ethyldibenzylidenesorbitol or dimethyldibenzylidenesorbitol or salts of diesters of phosphoric acid, e.g. sodium 2,2′-methylenebis(4,6-di-tert-butylphenyl) phosphate. The content of nucleating agents in the propylene polymer composition is generally up to 5% by weight.

Such additives are generally commercially available and are described, for example, in Gächter/Müller, Plastics Additives Handbook, 4th Edition, Hansa Publishers, Munich, 1993.

In a preferred embodiment, the transparent polypropylenes contain from 0.1 to 1% by weight, preferably from 0.15 to 0.25% by weight, of a nucleating agent, in particular dibenzylidenesorbitol or a dibenzylidenesorbitol derivative, particularly preferably dimethyldibenzylidenesorbitol.

The containers are used for packaging or storing articles from the area of clothing, sports articles, toys or home worker articles. For example, they are suitable for packaging or storing footwear of all types, e.g. shoes, sandals, boots, sports shoes, roller blades or ski boots, laundry, tennis articles, toys such as toy cars or building blocks or home worker articles such as tools, screws or nails. In particular, the containers are used for packaging or storing shoes.

The containers have wall thicknesses of at least 0.8 mm and preferably at least 1.0 mm. The wall thickness of the containers is generally approximately equal in all regions of the containers. However, they can also have reinforced regions or ribs. The containers generally have dimensions which make it possible to pack the articles, in particular the shoes, easily.

Preferred containers are made up of two parts and consist of a box-shaped receptacle and a lid. The receptacle and the lid can be joined to one another, in particular via a film hinge. The box-shaped receptacle and the lid are preferably configured so that in the closed state of the containers the receptacle and the lid lock into place.

Furthermore, the receptacles are preferably configured so that they can be stacked inside one another in the empty state. This is usually achieved by giving the receptacles a conical shape. Preference is also given to the upper rim of the receptacles being reinforced around the outside to provide stiffening. In addition, this makes it simpler to achieve a locking into place of receptacle and lid in the closed state of the containers.

A possible design of a preferred container made up of a box-shaped receptacle and a lid is shown in the attached figure.

The lids are preferably designed with short side parts which are usually between 10 and 20 mm high. Preference is also given to the lower rim of the lid being reinforced around the inside to provide stiffening. In addition, this makes it simpler to achieve a locking into place of receptacle and lid in the closed state of the containers.

The containers are preferably produced by injection molding. However, the containers can also be obtained by forming, for example folding, extruded sheets and in particular extruded corrugated sheets.

The present invention further provides containers comprising transparent polypropylene, with the containers having wall thicknesses of at least 0.8 mm, wherein the transparent polypropylene is a propylene homopolymer or propylene copolymer which has a haze value of ≦40%, based on a thickness of the polypropylene of 1 mm and measured on injection-molded test specimens, and has a tensile modulus of 2 700 MPa and a Charpy notched impact strength at 0° C. of ≧3 kJ/m² and the containers are provided at the bottom with a material which has a coefficient of sliding friction which is greater than that of the transparent polypropylene. This material prevents, or at least reduces, slipping of the packed or stored articles such as shoes. Examples of suitable materials having a coefficient of sliding friction which is higher than that of the transparent polypropylene are elastomers or thermoplastic elastomers such as thermoplastic polyolefins or styrene oligoblock copolymers. Suitable thermoplastic polyolefins are marketed, for example, by Basell under the name Adflex. In general, the containers are provided at the bottom with the material having the increased coefficient of sliding friction only in some regions. These regions can be, for example, oval, in the form of rectangular strips or also in the shape of a foot. Production can be carried out, for example, by two-component injection molding. However, it is also possible to manufacture the containers and moldings of the material having the increased coefficient of sliding friction separately and then to fix the moldings to the container, for example by adhesive bonding.

The present invention further provides systems for packaging or storing articles from the area of clothing, sports articles, toys or home worker articles, with at least two objects being present in a package, wherein the objects are surrounded by a container comprising a transparent polymer and having a wall thickness of at least 0.8 mm and at least two objects are separated from one another by a transparent flexible film. Such systems make it possible to readily see articles which consist of at least two objects and are packaged in a form which ensures that the objects are protected from impact against one another or with the walls of the package during transport of the packaging systems.

Examples of suitable transparent polymers which can be used for producing the containers of the systems are polystyrene, polycarbonate, styrene-butadiene block copolymers and polypropylene, with the above-described transparent polypropylenes being particularly useful.

Preferred transparent films are flexible and have a low stiffness. Furthermore, preferred transparent films are produced from a material which has a coefficient of sliding friction which is higher than that of the transparent polymer. Suitable transparent films can be produced, for example, from thermoplastic polyolefins, e.g. from thermoplastic polyolefins as are marketed by Basell under the name Adflex.

The present invention further provides reusable packaging systems for packaging clothing, sports articles, toys or home worker articles and in particular shoes wherein containers comprising a transparent polymer and having a wall thickness of at least 0.8 mm are used for packaging the clothing, sports articles, toys or home worker articles and smaller containers which fit accurately into the containers or can be hung into the containers are made available for reuse of the containers. These inserts are preferably made of the same transparent polymer from which the containers are made. The inserts can also be configured as sorting containers having a plurality of compartments, for example from 2 to 10, preferably from 4 to 8, compartments.

Suitable inserts can be sold empty as supplements for the further use of the containers originally serving as packaging material. However, the inserts can also be sold already filled, i.e. then as reusable packaging for other articles. Suitable articles which can be sold packed in such inserts are, for example, shoe care products such as tubes of polish, cleaning equipment or cleaning cloths or sewing requisites such as needles, yarns or buttons.

Suitable transparent polymers which can be used for producing the containers of the systems are, for example, polystyrene, polycarbonate, styrene-butadiene block copolymers of polypropylene, with the above-described transparent polypropylene being particularly useful.

1. A method comprising packaging items in transparent polypropylene containers wherein the containers have wall thicknesses of at least 0.8 mm, and wherein the transparent polypropylene is a propylene homopolymer or propylene copolymer which has a haze value of ≦40%, based on a thickness of polypropylene of 1 mm and measured on injection-molded test specimens, and has a tensile modulus of ≧700 MPa and a Charpy notched impact strength at 0° C. of ≧3 kJ/m² wherein the items are clothing sports articles toys or home worker articles.

2. The method of claim 1, wherein the clothing is shoes.

3. The method of claim 1 wherein the containers are in two parts and consist of at least one box-shaped receptacle and a lid, where the receptacle and the lid can be joined to one another.

4. The method of claim 3 wherein the box-shaped receptacle and the lid are configured so that in the closed state of the containers the receptacle and the lid lock into place.

5. The method of claim 3 wherein the at least one receptacle are configured so that they can be stacked inside one another in the empty state.

6. The method of claim 1 wherein the containers are produced by injection molding.

7. A container comprising transparent polypropylene, wherein the containers have wall thicknesses of at least 0.8 mm, and wherein the transparent polypropylene is a propylene homopolymer or propylene copolymer which has a haze value of ≦40%, based on a thickness of the polypropylene of I mm and measured on injection-molded test specimens, and has a tensile modulus of ≧700 MPa and a Charpy notched impact strength at 0° C. of ≧3 kJ/m² and the containers are provided at the bottom with a material which has a coefficient of sliding friction which is greater than that of the transparent polypropylene.

8. The method of claim 1 wherein the containers are provided at the bottom with a material which has a coefficient of sliding friction which is greater than that of the transparent polypropylene.

9. A system for packaging or storing articles from the area of clothing, sports articles, toys or home worker articles, comprising at least two objects being present in a package, wherein the objects are surrounded by a container comprising a transparent polymer and having a wall thickness of at least 0.8 mm and at least two objects are separated from one another by a transparent flexible film.

10. A reusable packaging system for packaging clothing, sports articles, toys or home worker articles, comprising containers comprising a transparent polymer and having a wall thickness of at least 0.8 mm and at least one smaller containers.

11. A method comprising storing items in transparent polypropylene containers, wherein the containers have wall thicknesses of at least 0.8 mm, and wherein the transparent polypropylene is a propylene homopolymer or propylene copolymer which has a haze value of ≦40%, based on a thickness of polypropylene of 1 mm and measured on injection-molded test specimens, and has a tensile modulus of ≧700 MPa and a Charpy notched impact strength at 0° C. of ≧3 kJ/m², wherein the items are clothing, sports articles, toys or home worker articles.
